(19) United States
(12) Patent Application Publication
(10) Pub. No.: US 2009/0000932 A1
(43) Pub. Date: Jan. 1, 2009

(54) KEYBOARD AND ELECTRONIC APPARATUS

(75) Inventors: Daisuke Hosokawa, Hamura-shi (JP); Hironori Motoe, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/140,169

(22) Filed: Jun. 16, 2008

(30) Foreign Application Priority Data
Jun. 28, 2007 (JP) 2007-170632

(51) Int. Cl. H01H 13/70

(52) U.S. Cl. 200/344

(57) ABSTRACT

According to one embodiment, a keyboard includes a keyboard base, a plurality of keytops arranged on the keyboard base, and a plurality of keytop support sections which are made of a synthetic resin, and each of which supports the keytop so that the keytop can ascend and descend with respect to the keyboard base. The keytop includes a base section which is made of a synthetic resin, and to which the keytop support section is coupled, and an outermost layer covering the base section. The outermost layer is harder than the base section.

### CROSS-REFERENCE TO RELATED APPLICATIONS

This application is based upon and claims the benefit of priority from Japanese Patent Application No. 2007-170632, filed Jun. 28, 2007, the entire contents of which are incorporated herein by reference.

### BACKGROUND

1. Field

One embodiment of the present invention relates to a keyboard provided with a plurality of keytops pressed down by fingertips of an operator. Further, the present invention relates to an electronic apparatus such as a portable commuter provided with a keyboard.

2. Description of the Related Art

An electronic apparatus such as a portable computer is provided with a keyboard for inputting information. A keyboard is provided with a keyboard base supported on a hosing of an electronic apparatus, a plurality of keytops arranged on the keyboard base, and a plurality of keytop support sections interposed between the keytops and the keyboard base.

A keytop is formed in one piece of a synthetic resin material. The keytop is formed into a square cap-like shape opened to the keyboard base.

Each keytop support section is provided with a pair of link levers made of a synthetic resin. The link levers are crossed, for example, in an X shape, and the crossing sections are rotationally coupled to each other through a pivot shaft. Upper ends of the link levers are coupled to an undersurface of the keytop. Lower ends of the link levers are coupled to a top surface of the keyboard base. As a result of this, the pair of link levers can be relatively turned upward and downward centering around the pivot shaft, and support the keytop so as to allow it to ascend and descend.

Each of the keytops of the keyboard includes a top surface to be depressed by a fingertip of the operator.

The top surface of the keytop is marked with a character or a symbol corresponding to a function of the keytop. If the top surface of the keytop is stained, the character or the symbols indicating the function of the keytop becomes difficult to be seen, and the operability of the keyboard is adversely affected.

Due to the above fact, heretofore, a keyboard in which each keytop is covered with a cover body is known as disclosed in, for example, Jpn. Pat. Appln. KOKAI Publication No. 4-31916. The cover body is formed of a resin material that is easily deformed into a cap-like shape, and is fixed to a keytop through an adhesive.

According to the keyboard disclosed in Jpn. Pat. Appln. KOKAI Publication No. 4-31916 described above, the cover body is made of a material more flexible than the keytop. For this reason, there is a tendency for the cover body to become insufficient in durability, and it is an undeniable fact that the cover body is deformed by the use for a long period of time. Accordingly, there are problems that the cover body is crushed and the appearance thereof is deteriorated, that the operability of the keytop is deteriorated, and the like.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment of the present invention;

FIG. 2 is an exemplary perspective view of the portable computer according to the first embodiment showing a state where a keyboard is detached from a first housing;

FIG. 3 is an exemplary cross-sectional view of the keyboard according to the first embodiment of the present invention;

FIG. 4 is an exemplary cross-sectional view of a keyboard according to a second embodiment of the present invention; and

FIG. 5 is an exemplary cross-sectional view of a keyboard according to a third embodiment of the present invention.

### DETAILED DESCRIPTION

Various embodiments according to the invention will be described hereinafter with reference to the accompanying drawings. In general, according to one embodiment of the invention, a keyboard comprises: a keyboard base; a plurality of keytops arranged on the keyboard base; and a plurality of keytop support sections which are made of a synthetic resin, and each of which is interposed between the keytop and the keyboard base, and supports the keytop so that the keytop can ascend and descend with respect to the keyboard base.

The keytop includes a base section which is made of a synthetic resin, and to which the keytop support section is coupled, and an outermost layer covering the base section. The outermost layer is harder than the base section.

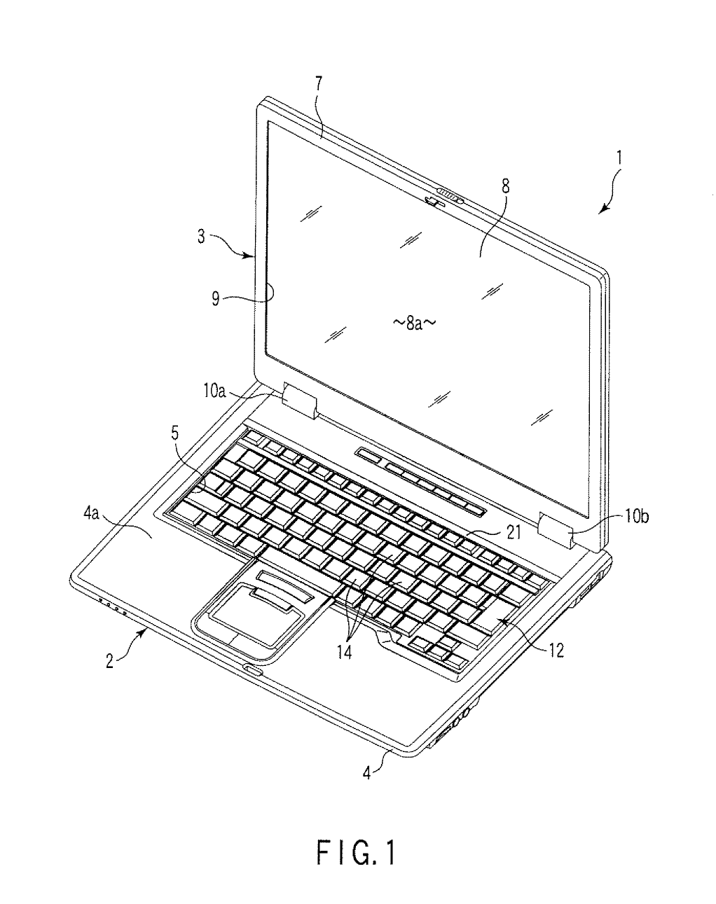

A first embodiment of the present invention will be described below on the basis of FIGS. 1 to 3.

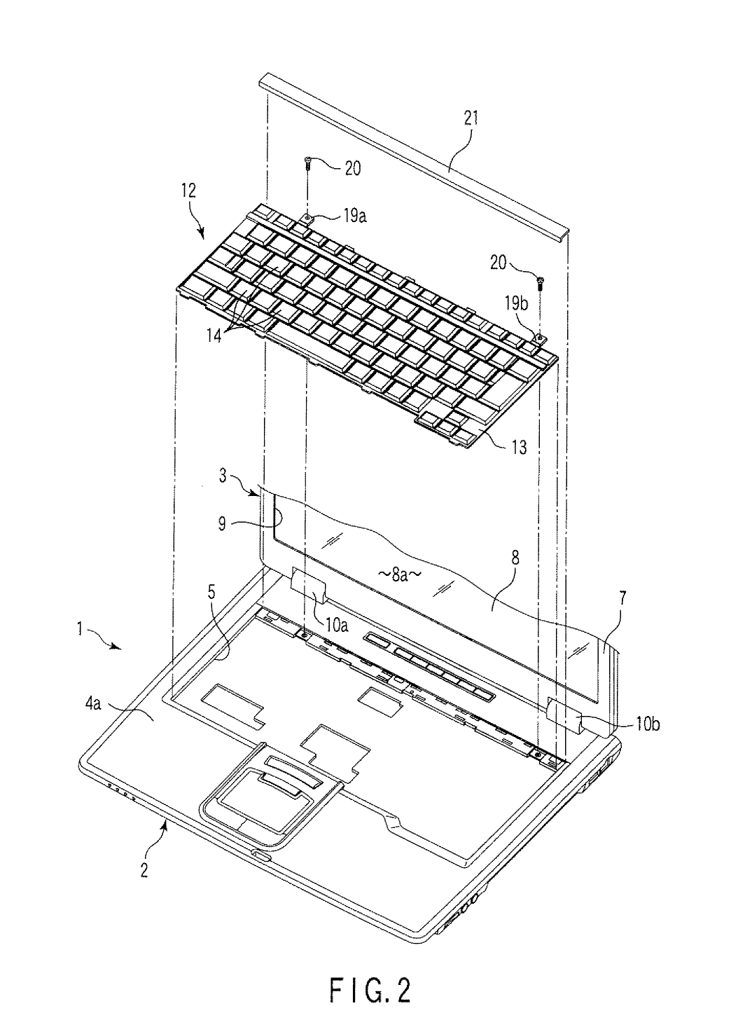

FIGS. 1 and 2 disclose a portable computer 1 which is an example of an electronic apparatus. The portable computer 1 is provided with a main unit 2, and a display unit 3. The main unit 2 includes a first housing 4 having a flat box-like shape. In the first housing 4, main constituent elements such as a printed wiring board on which a CPU is mounted, and a hard disk drive are housed. The first housing 4 has a flat top surface 4a. A keyboard mounting section 5 is formed in the central part of the top surface 4a.

The display unit 3 includes a second housing 7 having a flat box-like shape, and a liquid crystal display panel 8 housed in the second housing 7. The liquid crystal display panel 8 includes a screen 8a. The screen 8a is exposed to the outside of the display unit 3 through an opening section 9 opened in the front of the second housing 7.

The display unit 3 is supported by a pair of hinge sections 10a and 10b protruding from a rear end part of the first housing 4. The display unit 3 can be turned around the hinge sections 10a and 10b between a closed position at which the display unit 3 is laid down on the main unit 2, and an opened position at which the display unit 3 rises from the rear end of the main unit 2.

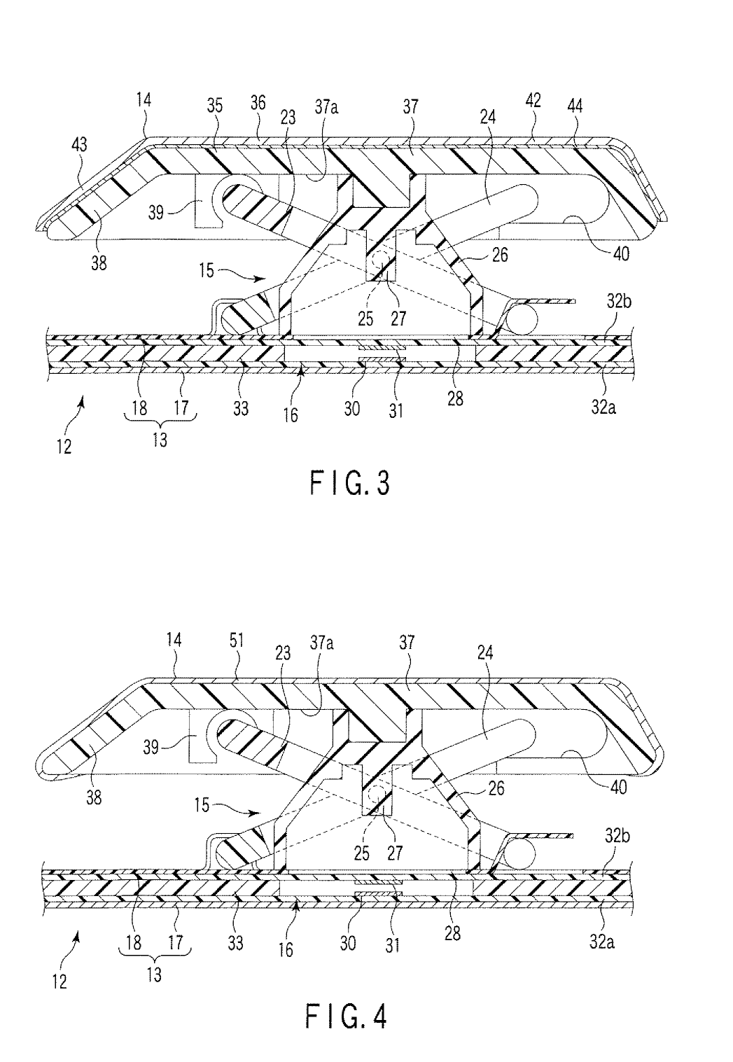

A keyboard 12 is set on the keyboard mounting section 5 of the first housing 4. As shown in FIG. 3, the keyboard 12 is provided with a keyboard base 13, a plurality of keytops 14, a plurality of keytop support sections 15, and a membrane switch 16.

The keyboard base 13 is formed into a flat plate-like shape that can be fitted into the keyboard mounting section 5. The keyboard base 13 includes a lower frame 17 made of metal and an upper frame 18 made of a synthetic resin. The upper frame 18 is stacked on the lower frame 17. A front end edge of the keyboard base 13 is hitched on the keyboard mounting section 5. At a rear end edge of the keyboard base 13, a pair of tongue pieces 19a and 19b protruding backwardly from the keyboard base 13 are formed. The tongue pieces 19a and 19b are fixed to the keyboard mounting section 5 by means of screws 20. The tongue pieces 19a and 19b, and the screws 20 are hidden by a belt-like decorative cover 21.

The keytops 14 are arranged on the keyboard base 13 according to a rule determined in advance. Each keytop 14 has a size that allows the keytop 14 to be depressed by a fingertip of the operator's hand.

The keytop support section 15 is interposed between the keytop 14 and the upper frame 18 of the keyboard base 13. The key top support section 15 of this embodiment is a pantograph type provided with a first link lever 23 and a second link lever 24.

Each of the first link lever 23 and the second link lever 24 is formed in one piece of a synthetic resin material. The first link lever 23 and the second link lever 24 are crossed in an X shape, and the crossing sections are rotationally coupled to each other through a pivot shaft 25. An upper end of the first link lever 23 is rotationally coupled to a front part of an undersurface of the keytop 14. A lower end of the first link lever 23 is slidably coupled to a top surface of the upper frame 18. Likewise, an upper end of the second link lever 24 is slidably coupled to a rear part of the undersurface of the keytop 14. A lower end of the second link lever 24 is rotationally coupled to the top surface of the upper frame 18.

Accordingly, the first link lever 23 and the second link lever 24 can be relatively turned upward and downward centering around the pivot shaft 25, and support the keytop 14 so as to allow it to ascend and descend with respect to the keyboard base 13.

In other words, the keytop 14 is configured to be given a stroke upwardly or downwardly between a standby position, at which the keytop 14 is pushed up above the keyboard base 13 and a depression position, at which the keytop 14 is lowered to be closer to the keyboard base 13.

A rubber spring 26 is interposed between the keytop 14 and the upper frame 18. The rubber spring 26 is formed in the shape of a cup or dome. The rubber spring 26 elastically pushes the keytop 14 toward the standby position at all times. At an upper end part of the rubber spring 26, a pressing boss 27 protruding downwardly is formed integral with the rubber spring 26. The pressing boss 27 is opposed to a through hole 28 formed in the upper frame 18.

The membrane switch 16 electrically detects the depression operation of the keytop 14, and generates an input signal. The membrane switch 16 is interposed between the lower frame 17 and the upper frame 18. The membrane switch 16 includes a fixed contact 30 and a moving contact 31. The fixed contact 30 is printed on an insulating sheet 32a. The moving contact 31 is printed on another insulating sheet 32b. The fixed contact 30 and the moving contact 31 are opposed to each other with a gap held between them below the pressing boss 27 of the rubber spring 26. The gap between the fixed contact 30 and the moving contact 31 is held constant by a spacer 33.

When the operator depresses the keytop 14 from the standby position toward the depression position by a fingertip of the operator's hand, the first and second link levers 23 and 24 turn downwardly while resisting the energizing force of the rubber spring 26. At the same time, the rubber spring 26 is compressed, and hence the pressing boss 27 depresses the insulating sheet 32b of the membrane switch 16 downwardly. As a result of this, the moving contact 31 is pressed against the fixed contact 30, and the membrane switch 16 is closed. Accordingly, the depression operation of the keytop 14 is electrically detected.

When the depression of the keytop 14 is released, the keytop 14 is pushed up from the depression position to the standby position by the energizing force of the rubber spring 26. As a result of this, the pressing boss 27 of the rubber spring 26 is separated from the moving contact 31, and hence the insulating sheet 32b is restored to its original shape. Accordingly, the moving contact 31 is separated from the fixed point 30, and the membrane switch 16 is opened.

As shown in FIG. 3, each keytop 14 of the keyboard 12 is constituted of a base section 35 and a cover 36. The base section 35 includes an upper wall 37 and a peripheral wall 38. The upper wall 37 and the peripheral wall 38 are formed of a synthetic resin material integral with each other. The upper wall 37 has a square shape of a size such that the operator can depress the upper wall 37 by a fingertip of the operator's hand. The peripheral wall 38 extends obliquely downward from the outer periphery of the upper wall 37. Thus, the base section 35 has the shape of a flat cap with the opening facing down, thereby constituting the fundamental outer hull of the keytop 14.

The upper wall 37 of the base section 35 has a lower surface 37a opposed to the keyboard base 13. A bearing section 39 and a guide groove 40 are formed integral with each other on the lower surface 37a of the upper wall 37. The bearing section 39 rotationally-receives the upper end of the first link lever 23. The guide groove 40 slidably receives the upper end of the second link lever 24.

The cover 36 is an example of the surface layer. The cover 36 includes a top panel 42 and a side panel 43. The top panel 42 and the side panel 43 are formed of a metallic material harder than, for example, the base section 35 and are formed as an integrated body. The top plate 42 is stacked on the upper wall 37 of the base section 35. The side panel 43 is stacked on the peripheral wall 38 of the base section 35. For this reason, the cover 36 has a cap-like shape that covers the base section 35 from above, and has sufficient rigidity that enables the cover 36 to maintain the cap-like shape by itself alone. It is desirable that stainless steel, which is excellent in corrosion resistance, and by which a texture peculiar to metal can be obtained be used as a metallic material constituting the cover 36.

In this embodiment, the cover 36 is fixed to the base section 35 by using an adhesive 44. Accordingly, the cover 36 is made integral with the base section 35.

The cover 36 is marked with a character, a symbol or the like indicating a function of the keytop 14 at a part of the top panel 42. The character, the symbol or the like is formed on the top face of the top panel 42 by means of, for example, printing, inscription or the like. Further, it is desirable that the top panel 42 of the cover 36 which is brought into contact with a fingertip of a hand be subject to, for example, an antibacterial treatment.

According to the first embodiment of the present invention, the keytop 14 of the keyboard 12 is provided with the cover 36 for covering the base section 35. The cover 36 is formed of a metallic material harder than the base section 35, and hence is excellent in durability. Accordingly, the cover 36 is hardly deformed from use extending over a long period of time, and the surface thereof is hardly scratched.

Therefore, the feel of depression of the keytop 14 by the fingertip becomes agreeable, and the operability of the keyboard is improved.

Furthermore, the metallic cover 36 provides a highly luxurious texture. Accordingly, the external appearance of the keytop 14 is improved, and the commercial value of the portable computer 1 including the keyboard 12 can be enhanced.

In addition, the base section 35, which is the outer hull of the keytop 14, is made of a synthetic resin, and hence the same manufacturability as a keyboard including a conventional keytop made of a synthetic resin can be secured. More specifically, in the keytop 14, a part thereof to which the upper ends of the first and second link levers 23 and 24 are coupled is the base section 35 made of a synthetic resin. Thus, forming the bearing section 39 and the guide groove 40 for receiving the first and second link levers 23 and 24 on the base section 35 is as easy as that involved in a conventional keytop.

Moreover, the base section 35 and the first and second link levers 23 and 24 which are rubbed against each other when the keytop 14 is operated are all made of a synthetic resin. Accordingly, one of the base section 35 and the pair of link levers 23 and 24 is not extremely worn away.

In other words, it is undeniable that when the entirety of the keytop is formed of a metallic material, the upper ends of the first and second link levers 23 and 24 made of a material softer than the metallic material are rubbed against the keytop made of metal to be worn away in an early stage. As a result of this, looseness and play are easily caused at the coupling part of the keytop and the first and second link levers 23 and 24, and the operability of the keytop is deteriorated.

Conversely, according to the first embodiment, the operability at the time of inputting information using the keyboard 12 becomes satisfactory.

The present invention is not particularly limited to the first embodiment, and the embodiment can be variously modified within the scope not deviating from the spirit of the invention to be carried out.

FIG. 4 discloses a second embodiment of the present invention.

The second embodiment differs from the first embodiment described above as regards an outermost layer of a keytop 14. The configuration of a keyboard 12 except the outermost layer is identical with that of the first embodiment.

As shown in FIG. 4, the keytop 14 is constituted of a base section 35 and a plated layer 51. The plated layer 51 is an example of the outermost layer. The plated layer 51 is formed by plating an upper wall 37 and a peripheral wall 38 of the base section 35 with a conductive layer, and the conductive plating covers the entire base section 35. The plated layer 51 is harder than the base section 35 made of a synthetic resin, and is hardly scratched. Further, the plated layer 51 has an external appearance and a texture peculiar to metal.

According to the second embodiment described above, by virtue of the presence of the plated layer 51, the feel of depression of the keytop 14 by the fingertip becomes agreeable, and the operability of the keyboard 12 is improved. Moreover, a texture with highly luxuriousness feel peculiar to metal can be obtained for each keytop 14, and hence the external appearance of the keytop 14 is improved. Accordingly, the commercial value of the portable computer 1 including the keyboard 12 can be enhanced.

Furthermore, the base section 35 is made of a synthetic resin as the first and second link levers 23 and 24, and thus the wear of both the keytop 14 and the first and second link levers 23 and 24 can be suppressed. Accordingly, it is possible to prevent looseness and play from being caused at the coupling part of the keytop and the first and second link levers 23 and 24, and the ascent and descent movement of the keytop 14 becomes smooth.

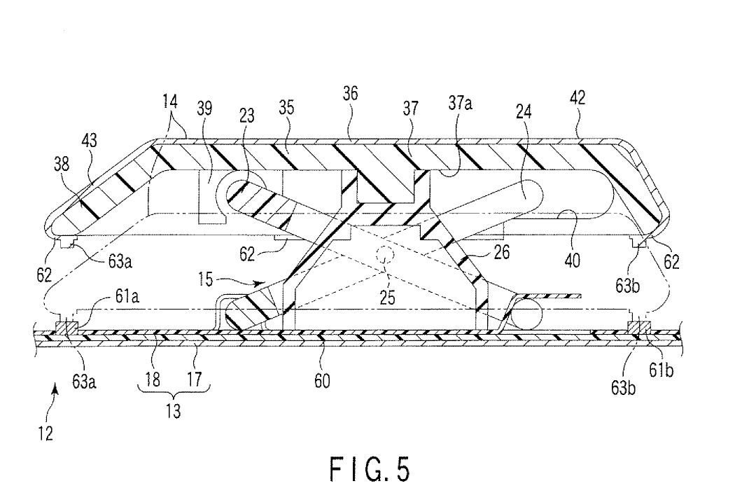

FIG. 5 discloses a third embodiment of the present invention.

The third embodiment differs from the first embodiment described previously in the point that a cover 36 of a keytop 14 doubles as a contact for electrically detecting a depression operation of the keytop 14. The other configuration of a keyboard 12 is identical with that of the first embodiment described previously.

As shown in FIG. 5, a switch substrate 60 having a sheet-like shape is arranged between a lower frame 17 and an upper frame 18 of a keyboard base 13. The switch substrate 60 includes a pair of fixed contacts 61a and 61b corresponding to each keytop 14. The fixed contacts 61a and 61b penetrate the upper frame 18 made of a synthetic resin and are exposed on the keyboard base 13. The one fixed contact 61a is positioned directly beneath a front end of the keytop 14. The other fixed contact 61b is positioned directly beneath a rear end of the keytop 14. Accordingly, the fixed contacts 61a and 61b are separated from each other in the depth direction of the keytop 14. Further, the fixed contacts 61a and 61b are positioned in the center of the keytop 14 in the width direction thereof.

The cover 36, which is an example of the outermost layer, is provided with a plurality of locking pieces 62 at a lower edge of a side panel 43. The locking pieces 62 are positioned at, for example, a front end, a rear end, and right and left lateral ends of the keytop 14, and are detachably hitched on a lower edge of a peripheral wall 38 of a base section 35. Accordingly, the cover 36 of the third embodiment is detachably supported by the base 35. As a result of this, by preparing, for example, a plurality of types of covers 36 different in color, the covers 36 can be freely changed at the whim of the operator.

A moving contact 63a is formed on the locking piece 62 positioned at the front end of the keytop 14 to be integral with the locking piece 62. Likewise, a moving contact 63b is formed on the locking piece 62 positioned at the rear end of the keytop 14 to be integral with the locking piece 62. The moving contacts 63a and 63b protrude from the locking pieces 62 slightly downwardly, and are opposed to the fixed contacts 61a and 61b, respectively.

When the keytop 14 is depressed from the standby position to the depression position by a fingertip of the hand as indicated by a two-dot chain line in FIG. 5, first and second link levers 23 and 24 turn downwardly while resisting the energizing force of a rubber spring 26. Further, the rubber spring 26 is compressed, and the moving contacts 63a and 63b of the cover 36 are brought into direct contact with the fixed contacts 61a and 61b of the switch substrate 60. As a result of this, the fixed contacts 61a and 61b are brought into a state where the contacts 61a and 61b are electrically connected to each other by the cover 36, and the cover 36 functions as a conductor. Accordingly the switch substrate 60 is closed and the depression operation of the keytop 14 is electrically detected.

When the depression of the keytop 14 is released, the keytop 14 is pushed up from the depression position to the standby position by the energizing force of the rubber spring 26. As a result of this, the moving contacts 63a and 63b of the cover 36 are separated from the fixed contacts 61a and 61b. Accordingly, the electrical conduction between the fixed contacts 61a and 61b is intercepted, and the switch substrate 60 is opened.

According to the third embodiment described above, it is possible, as in the first embodiment, to enhance the external appearance, the durability, and the operability at the time of inputting information of the keytop 14.

Furthermore, the moving contacts 63a and 63b of the cover 36 are brought into direct contact with the fixed contacts 61a and 61b on the keyboard base 13, and hence the sensation of depression of the keytop 14 can be easily obtained. Moreover, the response from the depression of the keytop 14 to the actual closing of the fixed contacts 61a and 61b is improved. Accordingly, the operability of the keyboard 12 at the time of inputting information thereto becomes excellent.

While certain embodiments of the inventions have been described, there embodiments have been presented by way of example only, and are not intended to limit the scope of the invention. Indeed, the novel methods and systems described herein may be embodied in a variety of other forms; furthermore various omissions, substitutions and changes in the form of the methods and systems described herein may be made without departing form the spirit of the inventions. The accompanying claims and their equivalents are intended to cover such form or modifications as would fall within the scope and spirit of the inventions.

What is claimed is:

1. A keyboard comprising:
a keyboard base;
a plurality of keytops arranged on the keyboard base; and
a plurality of keytop support sections which are made of a synthetic resin, and each of which is interposed between the keytop and the keyboard base, and supports the keytop so that the keytop can ascend and descend with respect to the keyboard base, wherein
the keytop includes a base section which is made of a synthetic resin, and to which the keytop support section is coupled, and an outermost layer covering the base section, and the outermost layer is harder than the base section.

2. The keyboard according to claim 1, wherein the outermost layer is a cover made of metal bonded to the base section.

3. The keyboard according to claim 1, wherein the outermost layer is a plated layer.

4. The keyboard according to claim 1, wherein the outermost layer is a cover made of metal detachably supported on the base section.

5. The keyboard according to claim 1, wherein the keyboard base includes a plurality of fixed contacts at a position corresponding to each keytop, and when the keytop is depressed toward the keyboard base, the cover made of metal is brought into contact with the fixed contacts, and electrically connects the fixed contacts to each other.

6. The keyboard according to claim 5, wherein the cover includes a plurality of moving contacts corresponding to the fixed contacts.

7. The keyboard according to claim 6, wherein in that the cover includes a plurality of locking pieces to be detachably hitched on a peripheral edge of the base section, and the moving contact is formed on the locking piece.

8. An electronic apparatus comprising:
a housing; and
a keyboard supported on the housing, the keyboard including
a keyboard base;
a plurality of keytops arranged on the keyboard base; and
a plurality of keytop support sections which are made of a synthetic resin, and each of which is interposed between the keytop and the keyboard base, and supports the keytop so that the keytop can ascend and descend with respect to the keyboard base, wherein
the keytop includes a base section which is made of a synthetic resin, and to which the keytop support section is coupled, and an outermost layer covering the base section, and the outermost layer is harder than the base section.

9. The electronic apparatus according to claim 8, wherein the outermost layer of the keytop is a cover made of metal, and the cover is bonded to the base section.

10. The electronic apparatus according to claim 9, wherein the keyboard base includes a plurality of fixed contacts at a position corresponding to each keytop, and when the keytop is depressed toward the keyboard base, the cover made of metal is brought into contact with the fixed contacts, and electrically connects the fixed contacts to each other.
